(19) United States
(12) Patent Application Publication
(10) Pub. No.: US 2012/0233046 A1
(43) Pub. Date: Sep. 13, 2012

(54) PROVIDING STATIONERY ASSET INFORMATION

(75) Inventors: Terrence H. Joyce, JR., Lakeville, MN (US); Justin M. Johnson, Oakdale, MN (US)

(73) Assignee: 3M Innovative Properties Company

(21) Appl. No.: 13/416,383

(22) Filed: Mar. 9, 2012

Related U.S. Application Data
(63) Continuation of application No. 61/450,792, filed on Mar. 9, 2011.

(51) Int. Cl. G06F 17/30; G06Q 30/00

(52) U.S. Cl. 705/35; 707/758; 707/E17.005

(57) ABSTRACT

A method and system for providing stationary asset information. A method includes receiving a request from a user for information related to stationary assets in a geographic area, collecting information related to stationary assets in the geographic area from at least one entity, converting the information and providing the converted information to the user. A system includes a first computer arranged to support an electronic user interface, wherein a user can request information related to stationary assets in a geographic area through the electronic user interface; and between the second computer and at least one entity. The second computer is arranged to collect information related to stationary assets in the geographic area from the entity. The information may be collected from a plurality of entities and may relate to assets located above or underground.

### CROSS REFERENCE TO RELATED APPLICATION

This application claims the benefit of U.S. Provisional Patent Application No. 61/450,792, filed Mar. 9, 2011, the disclosure of which is incorporated by reference herein in its entirety.

### FIELD OF DISCLOSURE

The present disclosure pertains to a method and system for providing information related to stationary assets to a user. In one embodiment, the present disclosure pertains to providing information related to assets buried underground collected from multiple entities.

### BACKGROUND

The task of locating stationary assets, whether underground, such as water, power, wastewater and gas pipelines, or above ground, such as power lines, fire hydrants, light poles, telephone poles, transformers, cable access boxes, hand boxes, valves, and manhole covers is important and can be costly. The challenges associated with asset location and mapping exist whether the asset is on public land, private land, or in any urban or suburban context. Assets in a given geographical area are frequently owned by different companies or government entities, installed over a period of many years, tracked on different maps with different coordinate systems and stored in different locations or databases.

Currently, if a company or individual intends to excavate or construct in a particular area, they can call a contract company. The contract company will in turn manually call different utilities or companies who may own assets located in that area. These utilities or companies then send a representative to physically mark the estimated location of the asset at the geographical location. Little, if any, other information related to the asset is provided to the entity requesting that information.

The current system presents multiple challenges for individuals engaging in construction, excavation or destruction. For example, because the marked location of an asset is frequently estimated, and as multiple entities may be marking multiple assets without having calibrated location coordinate systems, the markings on the ground may not reflect the actual location of the assets. Further, the information provided may not be adequate for workers in the area to adopt appropriate safety procedures. If a worker has insufficient information about the location of an electrical or gas line and the associated voltage or pressure, the worker may be injured if they attempt to dig in the area of the asset. Additionally, the process of requiring a representative from each asset owner or manager to physically mark the location of every asset can be inefficient and time consuming. In light of the challenges associated with the current system, a system that more efficiently provides more detailed and accurate information related to stationary assets would be welcomed.

### SUMMARY

The present disclosure is directed generally to a method and system of providing information related to stationary assets. Such a system can provide a more efficient method of providing information, including but not limited to location information, about stationary assets to a user of the system. The system or method can further decrease cost by providing information through a centralized source and eliminating the need for multiple individuals to physically mark asset location. The present disclosure can further improve safety for workers in the geographical location containing the asset by providing more accurate and detailed information about the asset.

Consistent with the above advantages, in one aspect, the present disclosure is directed to a method of providing stationary asset information. The method includes receiving a request from a user for information related to stationary assets in a geographic area. The method further includes collecting information related to stationary assets in the geographic area from at least one entity, converting the information, and providing the converted information to the user.

In another instance, the present disclosure is directed to a system for providing stationary asset information. The system includes a computer system arranged to support an electronic user interface, wherein a user can request information related to stationary assets in a geographic location through the electronic user interface. The computer system is also arranged to collect information related to stationary assets in the geographic area from the entity.

### BRIEF DESCRIPTION OF THE DRAWINGS

The invention may be more completely understood in consideration of the following detailed description of various embodiments of the invention in connection with the accompanying drawings, in which:

FIG. 1 shows a block diagram of a system for providing stationary asset information;

FIG. 2 shows a flow chart for a method for providing stationary asset information;

FIGS. 3A-3C show examples of information related to stationary assets, wherein,

FIG. 3A is a photograph of an exemplary stationary asset,

FIG. 3B is a schematic drawing of an exemplary stationary asset, and

FIG. 3C is an example of textual information related to an exemplary stationary asset;

FIG. 4 shows an example of interactive converted information related to stationary assets in a geographic location; and

The accompanying drawings are shown to illustrate various embodiments of the present invention. It is to be understood that the embodiments may be utilized, and structural and design changes may be made, without departing from the scope of the present invention. The figures are not necessarily to scale. Like numbers in the figures generally refer to like components. However, it will be understood that the use of a number to refer to a component in a given figure is not intended to limit the component in another figure labeled with the same number.

### DETAILED DESCRIPTION

The present disclosure relates to providing stationary asset information, specifically, stationary asset information from separate or multiple entities. A method or system consistent with the present disclosure can provide multiple advantages, including increased efficiency, reduced cost, increased safety, and increased information accuracy.

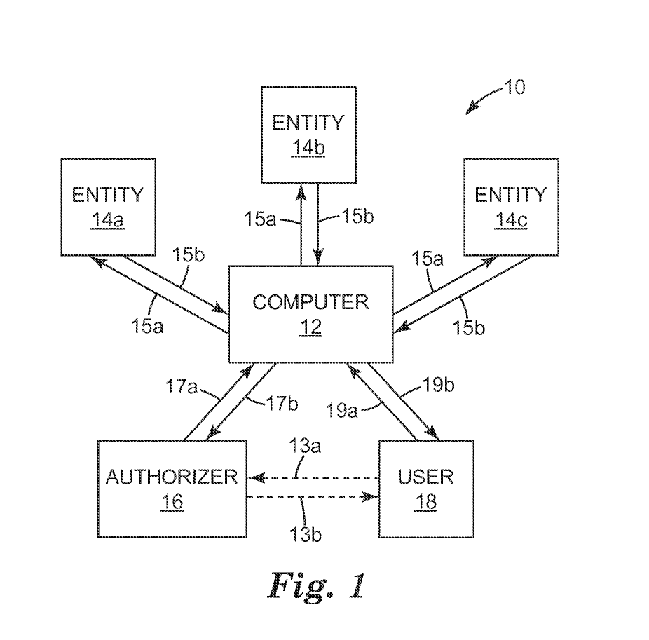

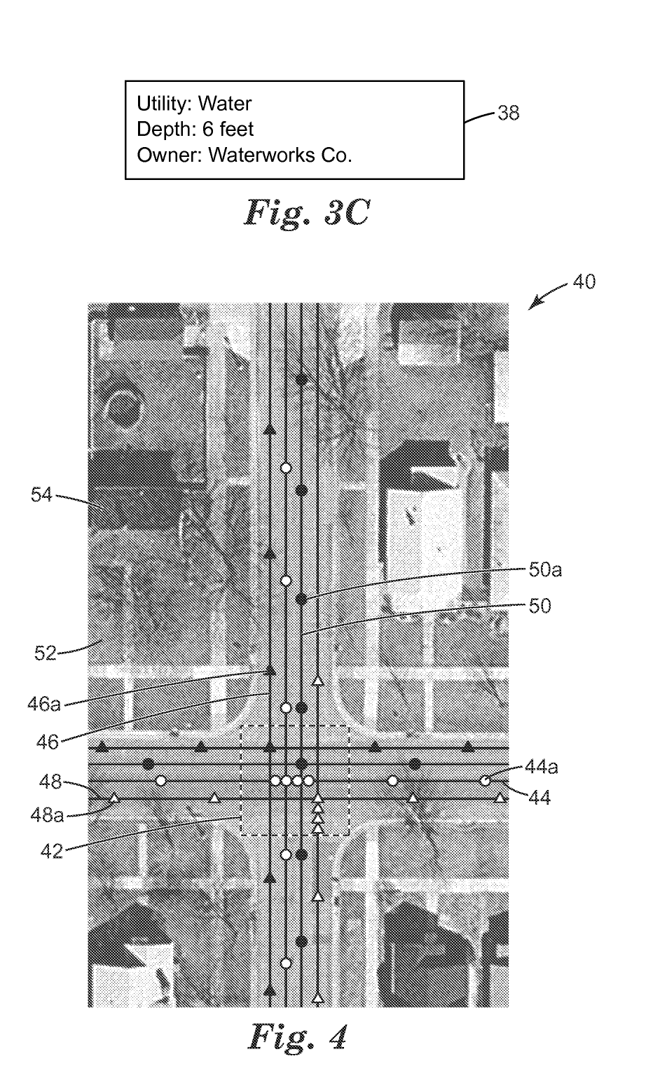

FIG. 1 shows a block diagram of a system 10 for providing stationary asset information. System 10 includes a computer system 12. Computer system 12 may be any entity capable of computing, such as a computer, a server, a cluster of computers or servers, cloud computing, server farm, server farms in different locations, etc. If computer system 12 includes multiple and separate components, the components can be electrically connected or interfaced with each other as appropriate. Computer system 12 can be arranged to support an electronic user interface whereby a user 18 can communicate by requesting 19a and receiving 19b information from computer system 12. When communicating with computer 12, a user 18 can request 19a information. Consistent with the present disclosure, the requested information can be related to stationary assets in a geographic area, as discussed in further detail with respect to FIG. 4A.

After receiving a request from a user 18 for information, computer system 12 can collect information from separate entities 14a-c. In some embodiments, there may be multiple users 18. In some embodiments, computer system 12 may collect information from a single entity 14a or in other embodiments, computer system 12 may collect information from multiple entities 14a-c. An entity 14a-c can be any individual or organization that owns or manages information relative to assets. In one embodiment, information related to assets buried underground, such as water, electric, and gas lines, may be requested, and in that embodiment, the entity could be the company or organization owning or operating any of these utilities. Collecting information can include requesting 15a information from a separate entity 14a-c and receiving 15b the requested information from the separate entity 14a-c. In some embodiments, computer system 12 can be electrically connected to information storage devices owned or managed by an entity 14a-c through a network or a series of network connections. In such an embodiment, computer system 12 can collect information from entity 14a-c electronically. In other embodiments collecting information may be completed partially electronically (e.g., computer 12 submitting an automated request to entity 14a) and partially manually (e.g., an individual within entity 14a transmitting the information back to computer 12).

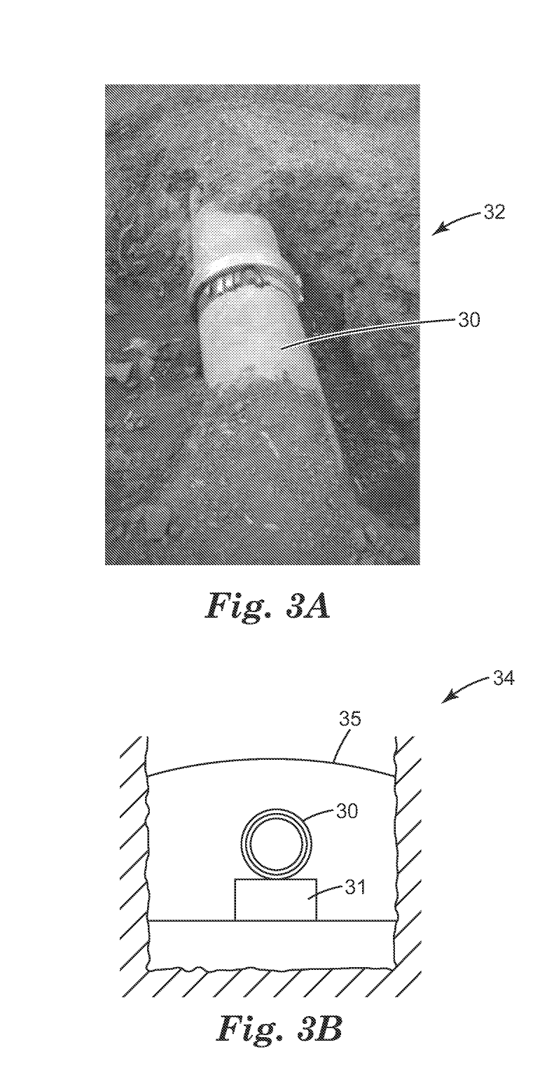

After computer system 12 collects the requested information, computer system 12 may convert the information, or may facilitate manual conversion of the information. For example, the collected information may be collected and/or provided in a variety of formats and may relate to a variety of types of information, including: location of an asset, type of an asset, status of an asset, owner of an asset, size of an asset, safety warnings related to an asset, photo of an asset, drawing of an asset, textual description of an asset, photo of area surrounding an asset, drawing of area around an asset, plan or profile drawing including an asset, cross-sectional drawing, survey drawing, model of an asset, three-dimensional model of an asset, or video of an asset. Such information is discussed in more detail with respect to FIGS. 3A-C.

When information is converted, converting can include ensuring that the information is in the proper format for user 18. In some scenarios, the collected information may already be in the proper format, and in other scenarios, it may be necessary to change the format of the information prior to providing 15b the information to user 18. A proper format for information can be defined by a user 18, or by any other appropriate entity, such as a manager of computer system 12.

In some embodiments, the information may also be combined. For example, when information is provided by multiple entities 14a-c or when a single entity 14a provides multiple pieces of information, the information may be combined into a single format. Information may be combined before or after it is converted. For example, several three dimensional models may be combined into a single three dimensional model. The single model may then be converted into schematic drawings based on a user's 18 request. In another embodiment, the collected information may be in multiple formats, such as a photograph, a schematic drawing, textual information and safety warnings. The photograph and textual information could be converted and combined with the schematic drawing into a single schematic drawing. The safety warnings could also be included on the schematic drawing. While these are only a couple of examples of converting and combining information, upon reading this disclosure, it will be apparent to one of skill in the art that many more potential variations upon the scenarios above are possible, consistent with the present disclosure.

After information is converted, it may be provided 15b to user 18. The converted information may be provided to user 18 such that it is made accessible to user 18 such that it is delivered, for example in electronic or printed format, to user 18. The converted information may be provided in a variety of formats, including: a photograph, text, drawings, coordinates, model or any other appropriate format. Additionally, the converted information may be provided in an interactive format, as discussed with more detail with respect to FIGS. 4A-B. The converted information may be electronic and downloadable such that it is accessible from a mobile device. This allows a user 18 or worker to access, manipulate and interact with the information while user 18 is at the geographic area the information relates to.

In one embodiment, computer system 12 may also be arranged to interact with an authorizer 16. For example, in the instance where construction is planned for a particular geographic area, such as a traffic intersection, an organization such as the Department of Transportation may be an authorizer 16. In this instance authorizer 16 may grant permission 17a for computer system 12 to collect information related to stationary assets in a geographic area from entities 14a-c, and for such information to be made available or provided or delivered to designated entities. In such a situation, authorizer 16 may grant permission 17a through electronic communication between an authorizer's computer system and computer system 12 to collect information. Computer system 12 may then provide 17b authorizer 16 with an alphanumeric pass code, electronic signature or certificate, or other security key to access the requested information. Authorizer 16 may then provide the pass code to any desired entity, such as user 18. In such a scenario, user 18 may be a contractor bidding 13a on the construction project for the Department of Transportation. In that instance authorizer 16 may provide 13b potential or successful bidders with a security key to access converted information related to stationary assets in a geographic location. While specific examples of an authorizer 16 and a user 18 are provided above, an authorizer or a user may be any individual, organization or entity. Multiple authorizers, users and levels of authorizers or users may interact with system 10 consistent with the scope of the present disclosure. For example, authorizer 16 and user 18 may communicate with each other through computer system 12 or through any other appropriate arrangement.

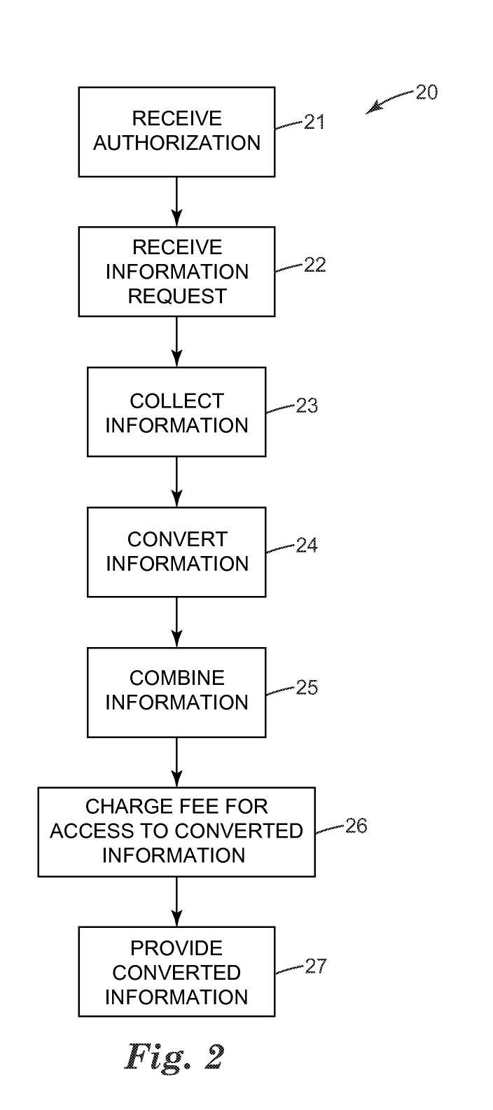

FIG. 2 shows a flow chart 20 for a method for providing stationary asset information. In step 21, a system or entity receives authorization from an individual or organization to collect information related to a particular geographic area and to provide that information to particular users.

In step 22, a system or entity receives an information request. An information request may be based on a geographic area, defined by coordinates, architectural or geographic features, landmarks, or by any other workable method. An information request typically requests information related to stationary assets in a geographic area. It may seek information regarding a particular type of asset (water, power, gas, etc.), assets with particular depth (above ground, below ground, no more than a defined depth below ground, etc.) or may request information based on any other appropriate parameter provided with the request.

Step 23 represents the collection of information in response to a request. As described above with respect to FIG. 1, information can be collected in a variety of ways, including both electronically and manually, and a combination of the two.

Steps 24 and 25 show converting and combining the information, respectively. As discussed above, the order of these steps may be reversed, and in some situations, it may be appropriate to omit or repeat these steps as necessary until collected information is in an appropriate format for the user.

Step 26 shows charging a fee for access to converted information. While step 26 is shown at a particular point in flowchart 20, step 26 can occur at any point in flowchart 20 consistent with the present application. In step 26, an authorizer or a user may be charged a fee, and the charge may occur at any point in the process shown in flow chart 20. The charge may be a flat fee, may be based on the amount or format of information provided, may be a subscription fee or any other fee model. Such a fee may provide financial justification for the process shown in flow chart 20.

Step 27 shows providing the converted information. The converted information may be provided to a user, authorizer, or other entity. As noted, information may be provided prior to charging a fee. The information may be provided in a variety of formats. For example, it may be automatically electronically transmitted to an intended recipient, such as a user or authorizer. Or an intended recipient may be required to login to the system through an electronic user interface or other format to access the information. Information may be downloadable to a mobile device, provided in paper format, or in another other appropriate method.

Several of the steps shown in flowchart 20 are considered optional. For example, any or all of steps 21 (receive authorization), 25 (combine information) and 26 (charge fee for access to converted information) may be omitted within the scope of the current disclosure. Other embodiments may combine other steps as shown in flowchart 20 and omit steps other than those discussed consistent with the present disclosure.

FIGS. 3A-3C show examples of information related to stationary assets. FIG. 3A shows a photograph 32 of an exemplary stationary asset 30, a water pipe. Such a photograph 32 may be taken by a utility company when installing the water pipe. When information is requested related to stationary assets located in the geographic area in which the water pipe is located, the utility company may provide a photograph 32 to enable a worker later excavating that area to correctly identify the pipe. Such a photograph 32 could be taken and stored by another entity, such as a construction company that installed the pipe, or by a company responsible for pipe maintenance. Any one of these could be an entity 14a-c as shown in FIG. 1.

FIG. 3B is a schematic drawing 34 of an exemplary stationary asset 30. The stationary asset 30 shown in drawing 34 could be the same pipe as shown in photograph 32 (FIG. 3A). In this drawing 34, surrounding features such as support 31 for the stationary asset 30 and ground level 35 are shown. While this is an example of a drawing 34 related to a stationary asset 30, a drawing consistent with this disclosure may include any desired features or pieces of information, such as legends, dimensions, coordinates, etc.

FIG. 3C is an example of textual information 38 related to an exemplary stationary asset. The stationary asset may be the same as shown in FIG. 3A or 3B, or may be a different asset. While the textual information 38 shown only relates to the type of utility, depth and owner, any desired textual information may be included, such as location coordinates, depth of the asset, properties of the asset such as diameter of a pipe, material the pipe is made of, installation date, contractor who installed it, size of the concrete power vault, thickness of the walls, and voltages present in the vault.

FIG. 4 shows an example of interactive converted information 40 related to stationary assets in a geographic area. The converted information 40 is in a form of a map of a geographic area 42 and the surrounding area. The map includes stationary features such as building 54 and tree 52. The location of a variety of stationary assets is also shown. For example, gas pipe 44, power line 46, water pipe 48 and wastewater pipe 50 are each shown. Gas node 44a is interactive such that, if converted information 40 is provided in an electronic format, a user could select gas node 44a to view additional information about gas pipe 44. Power node 46a, water node 48a and wastewater node 50a provide similar opportunities for a user to identify more information regarding each asset, respectively. While this is one example of converted information, converted information can be provided in a variety of forms and formats as discussed throughout this disclosure, including a photograph, text, drawing, coordinates, or model provided in electronic, downloadable, hard copy or any other appropriate format.

FIG. 4 can be interactive such that when a user selects, for example, water node 48a additional information is displayed about water node 48. For example, that information could be information such as shown in 3A, 3B or 3C. Any different or additional types of textual information or other information could be displayed when a user selects a node. For example, a photograph of the asset at that location, a rotatable CAD model or drawing, a magnified view of an asset, a safety warning related to the asset, or any other appropriate form of information.

### EXAMPLES

To facilitate the elements of this invention presented below, the identification of or arrangement of certain matters that are not necessary elements of the invention are considered to add additional advantages to the invention. For example, it is desirable to identify or have identified entities that presently or may have in the past, owned, controlled and/or have been responsible for assets in specific geographic locations; and further entities that may have information regarding said assets, such as type of asset, status of asset, present—and where appropriate—former owner of the asset, size of asset, safety warnings related to assets, textual description of asset, model of assets, photos or drawings of area surrounding assets, plan or profile drawing of assets, and chart, map, plot and/or textual description of the location of assets present in those specific geographic locations. Another preferred element to have arranged or to be able to arrange is agreement or contract specifying that an entity having or managing the system of this invention or performing the method of this invention has the right to acquire any or all, of the above identified information from the holders of such information.

In one embodiment of the method of this invention, an entity that has a use for information pertaining to stationary assets in a geographic location would make a request for such information to the entity or perhaps to the computer system performing the method of this invention. Upon receipt of the request for information pertaining to stationary assets in a geographic location, the entity or the physical device would then collect the requested information from holders of information about stationary assets in the geographic area that was the subject of the information request. Upon collection of the information, the entity or the physical device would determine in what form and by what method the requester of the information could best use the information. The determination of the form and method of delivery of the requested information could be part of the initial information request. It is also possible that no form of information or method of delivery is made by the information requester. In such event, the entity or computer system receiving the information could assess the form or forms in which the information existed as collected from the holders of the information and determine a consistent format for the information or perhaps a form more suited to the end need(s) of the requestor of the information and convert the information to such form or forms. Post conversion of the collected information, the entity or physical device would then provide the converted stationary asset information to the requester of the information. The provision of information to the requester of the information could be by the method that the requester of the information requested said information to be delivered, by the same method in which the information request was received or by any other method selected by the provider of the requested information.

In another highly detailed embodiment of the method of this invention, an entity such as a Department of Transportation that has need for highway repair work to be done at a specific highway intersection may call for bid proposals from highway reconstruction entities to bid on the repair process. In order for the highway reconstruction entities to make an informed bid, beyond the specifications to be provided highway reconstruction, there is need for information pertaining to stationary assets above, below and at grade that may or would impact the highway reconstruction and the cost thereof This is information generally not within the domain of the entities with a need to do work at a specific geographic location, such as in this example, the Department of Transportation to reconstruct a highway intersection as well as those that perform said work. In this embodiment of the invention, the Department of Transportation would contract with the entity performing the method of providing information of this invention, and would indicate which entities it authorizes to receive pertinent information relative to a specific geographic location. In one embodiment, the performing entity would send log in information to the entity(ies) authorized to receive information. In response, the authorized entity(ies) would log in and request information specific to their needs over whatever portion of the specified geographic area they have need to know of the presence of stationary assets. The collection, conversion and provision of the requested information by the method of this invention could be as described above. Further, the performer of the method of this invention could record the transaction(s) (authorizations, information requests) and invoice for services provided. All information collected, converted and provided to the users of the information by the entity performing the method of this invention could be destroyed by the entity performing the method of this invention, so that no information in the form collected, converted or provided remains in existence at the performing entity of the invention.

An embodiment of a system for providing stationary asset information could be a computer system. The computer system would preferably include a capability for a user to interact with the system, such as an electronic user interface. Using the electronic user interface the user thereof would be able to interact with the system and would be able to submit a request for information related to stationary assets in a geographic location. The computer system would further preferably be electronically connected to any entity(ies) having information pertaining to any aspect of a stationary asset in a geographic location.

Many modifications and other embodiments of the present disclosure will come to mind to one skilled in the art to which this disclosure pertains after reading the descriptions and viewing the associated drawings disclosed herein. Therefore, it is to be understood that the invention is not to be limited to the specific embodiments disclosed and that modifications and other embodiments are intended to be included within the scope of the present claims. Although specific terms and examples are employed herein, they are used in a generic and descriptive sense, not for purposes of limitation.

What is claimed is:

1. A method of providing stationary asset information comprising:
(a) receiving a request from a user for information related to stationary assets in a geographic area;
(b) collecting information related to stationary assets in the geographic area from at least one entity;
(c) converting the information; and
(d) providing the converted information to the user.

2. The method of claim 1, wherein step (b) comprises collecting information related to stationary assets in the geographic area from a plurality of entities.

3. The method of claim 2, further comprising, either before or after step (c), combining the information from the plurality of entities.

4. The method of claim 1, further comprising receiving authorization from an authorizer to provide the converted information to the first user.

5. The method of claim 1, wherein at least one of the stationary assets is located underground.

6. The method of claim 2, wherein at least one of the plurality of entities is an owner of at least one of the stationary assets.

7. The method of claim 1, wherein the information relates to at least one of: location of an asset, type of an asset, status of an asset, owner of an asset, size of an asset, safety warnings related to an asset, photo of an asset, drawing of an asset, textual description of an asset, photo of area surrounding an asset, drawing of area around an asset, plan and profile drawing including an asset, cross-sectional drawing, survey drawing, model of an asset, three-dimensional model of an asset, or video of an asset.

8. The method of claim 1, wherein the converted information is in the form of at least one of: a photograph, text, drawings, coordinates, textual data, or model.

9. The method of claim 1, wherein the converted information is in the form of at least one of: a photograph, text, drawings, coordinates, or model.

10. The method of claim 1, wherein the converted information is in an interactive format.

11. The method of claim 1, wherein the converted information is accessible from a mobile device.

12. The method of claim 1, further comprising the step of: (e) charging a fee for access to the converted information.

13. A system for providing stationary asset information, the system comprising:
computer system arranged to support an electronic user interface, wherein a user can request information related to stationary assets in a geographic area through the electronic user interface; and wherein the computer system is arranged to collect information related to stationary assets in the geographic area from the entity.

14. The system of claim 13, wherein the computer system is further arranged to convert the information.

15. The system of claim 14, wherein the computer system is further arranged to provide access to the converted information through the electronic user interface.

16. The system of claim 13, wherein at least one of the stationary assets is located underground.

17. The system of claim 13, wherein the computer system is arranged to collect information related to stationary assets in the geographic area from a plurality of entities.

18. The system of claim 17, wherein at least one of the plurality of entities is an owner of at least one of the stationary assets.

19. The system of claim 13, wherein the information relates to at least one of: location of an asset, type of an asset, status of an asset, owner of an asset, size of an asset, safety warnings related to an asset, photo of an asset, drawing of an asset, textual description of an asset, photo of area surrounding an asset, drawing of area around an asset, plan or profile drawing including an asset, cross-sectional drawing, survey drawing, model of an asset, three-dimensional model of an asset, or video of an asset.

20. The system of claim 13, wherein the converted information is in the form of at least one of: a photograph, text, drawings, coordinates, and a model.

21. The system of claim 14, wherein the converted information is in the form of at least one of: a photograph, text, drawings, coordinates, and a model.

22. The system of claim 14, wherein the converted information is in an interactive format.

23. The system of claim 14, wherein the converted information is accessible from a mobile device.

24. The system of claim 14, wherein the computer system is further arranged to charge a fee for access to the converted information.
